(19) United States
(12) Patent Application Publication
(10) Pub. No.: US 2009/0208841 A1
(43) Pub. Date: Aug. 20, 2009

(54) METHOD FOR PRODUCING ELECTRODE SHEET

(75) Inventor: Shinji Naruse, Tokyo (JP)

Correspondence Address: WENDEROTH, LIND & PONACK, L.L.P., 1030 15th Street, N.W.,, Suite 400 East, Washington, DC, 20005-1503, US

(73) Assignee: DUPONT TEIJIN ANVANCED PAPERS, LTD.

(21) Appl. No.: 12/309,649

(22) PCT Filed: Jul. 20, 2007
(86) PCT No.: PCT/JP2007/064721

§ 371 Date: Jan. 26, 2009

(30) Foreign Application Priority Data
Jul. 25, 2006 (JP) 2006-202373

(51) Int. Cl. H01M 4/02; H01G 9/04; H01M 4/04

(52) U.S. Cl. 429/209; 361/500; 427/58

(57) ABSTRACT

This invention discloses a method for producing an electrode sheet adapted to high-temperature drying and to charge and discharge under high voltage, comprising applying onto a collector a slurry which comprises an electrode active material, electroconductive agent, binder and solvent, using as the binder fibrid of meta-aramid, and pressing the electrode sheet.

### TECHNICAL FIELD

This invention relates to a method for producing electrode sheet which is useful for constructing electrode of electric/electronic parts such as capacitors, lithium secondary batteries.

### BACKGROUND ART

As typified by the recent progress in electronic instruments such as portable communication devices or high-speed information processors, reduction in size and weight and advance in technical performance of electronic machines and instruments are remarkable. In particular, much is expected of small size, light weight, high capacity and long-term storable high performance capacitors and batteries. Their broader application is planned and development of their parts is under rapid progress.

To meet the expectation, necessity for development of technology and higher quality for the binder to bind the electrode active material in electrode sheet also is increasing. Of the various characteristic properties required for the binder, the following three are found to be particularly important:
1) high electrode active material-binding ability,
2) high electroconductivity in its binding state of the electrode active material, i.e., in the electrode sheet, and
3) good wettability with the electrolytic solution in its binding state of the electrode active material, i.e., in the electrode sheet.

Conventionally, for example PVdF (polyvinylidene fluoride), PTFE (polytetrafluoroethylene), SBR (styrene-butadiene rubber) latex and the like have been widely used as the binder materials.

As a means to provide a negative electrode active material for secondary batteries of high charge-discharge efficiency, on the other hand, for example JP 2001-345103A discloses use of aramid (aromatic polyamide) as the negative electrode active material which also serves as the binder for secondary batteries in which an organic macromolecule having electrochemically active carbonyl group in its main chain or side chain is used as a part of the negative electrode active material. However, in the Official Patent Gazette, distinction between meta-aramid and para-aramid is ambiguous, and as to the production method the Gazette states no further than that the substance to serve as the negative electrode active material and aramid are mixed, applied onto the collector metal and dried. There is no description given as to pressing the electrode sheet in which aramid is used as the binder, after the drying.

### DISCLOSURE OF THE INVENTION

Electrode sheets in which binders of aforesaid PVdF (polyvinylidene fluoride), PTFE (polytetrafluoroethylene), SBR (styrene-butadiene rubber) latex and the like are used show favorable physical properties, but still cannot fully cope with the high voltage resistance, high capacity and large power output recently required for capacitors, batteries and the like for electric cars, and furthermore with the high-temperature drying of electrode group comprising collectors, electrodes and separators, as previously proposed by the present inventors (JP Appln. No. 2006-073898) as a means to meet the above requirements.

For a binder in the electrode sheet in electric/electronic parts of such capacitors, batteries and the like which are required to have high voltage resistance, high capacity and large power output, it is required that it satisfies all of the following five property requirements at the same time:
1) high electrode active material-binding ability,
2) high electroconductivity in its binding state of the electrode active material, i.e., in the electrode sheet,
3) good wettability with the electrolytic solution in its binding state of the electrode active material, i.e., in the electrode sheet,
4) high heat resistance, and
5) good electrochemical stability.
   In particular, heat resistance is important for performing high-temperature drying of the electrode group comprising collectors, electrodes and separators. Also the electrochemical stability is considered extremely important, for preventing deterioration in capacity and power output at charging and discharging under high voltage, for electric/electronic parts such as capacitors, batteries and the like serving as driving power source of, e.g., electric cars.

Under the current situation as above, I have engaged in concentrative studies with the view to develop highly heat resistant electrode sheet which can deal with the high voltage resistance, high capacity and large power output currently in demand, and come to complete the present invention.

Thus the present invention provides a method for producing an electrode sheet which comprises producing an electrode sheet by applying a slurry comprising an electrode active material, conductive agent, binder and solvent onto a collector, characterized in that meta-aramid fibrid is used as the binder, and that the electrode sheet is pressed.

The electrode sheet produced according to the method of the invention exhibits high heat resistance and satisfactorily high fill ratio of electrode active material. Because electrochemically stable meta-aramid is used as the binder, the electrode sheet can be dried at high temperatures, and can be advantageously utilized as electrode sheet for electric/electronic parts of high voltage resistant capacitors, batteries and the like. Also the electric/electronic parts of capacitors and batteries using the electrode sheet produced by the method of the invention can be used even under the environments of high voltage and heavy electric current, such as of electric cars, and therefore are very useful.

Hereinafter the invention is explained in still further details.

### Electrode Active Material:

The electrode active material to be used in the invention is subject to no particular limitation, so long as it functions as an electrode of capacitors and/or batteries. Specifically, for example, for a capacitor carbon materials such as active carbon, carbon foam, carbon nanotube, polyacene, nanogate carbon and the like which are used in electric double layer capacitors and the like which store electricity utilizing the electric double layer discovered by Helmholtz in 1879; metal oxides which can also use pseudo-capacity accompanying oxidation-reduction reaction, conductive polymers, organic radicals and the like can be named. For batteries, in particular, lithium ion secondary batteries, metal oxides of lithium such as lithium cobalt oxide, lithium chromium oxide, lithium vanadium oxide, lithium chromium oxide, lithium nickel oxide, lithium manganese oxide and the like can be used as the positive electrode, and as the negative electrode, carbonaceous materials such as natural graphite, artificial graphite, resinous charcoal, carbides of natural substances, petroleum coke, coal coke, pitch coke and mesocarbon microbeads; and lithium metal and the like can be used.

### Conductive Agent:

In the present invention, conductive agent is subject to no particular limitation so long as it has the function to improve electrical conductivity of the electrode sheet. For example, carbon blacks such as acetylene black, Ketchen Black and the like can be conveniently used.

### Meta-Aramid:

In the present invention, meta-aramid encompasses linear high molecular polyarylamide compounds in which at least 60% of amide bonds directly bind at mutually meta-positions on aromatic rings, specific examples including polymetaphenylene isophthalamide and copolymers thereof. These meta-aramids can be industrially manufactured by per se known interfacial polymerization method, solution polymerization method or the like using, for example, isophthalic acid chloride and metaphenylenediamine, and are commercially available but are not limited thereto. Of these meta-aramids, polymetaphenylene isophthalamide is particularly preferred for its characteristic properties such as favorable shaping workability, heat adherability, incombustibility and heat resistance.

### Meta-Aramid Fibrid:

Fibrid of meta-aramid refers to fine film-formed meta-aramid particles having paper-making property, which are also called meta-aramid pulp [cf. JP Sho 35 (1960)-11851B, JP Sho 37 (1962)-5752B].

It is well known that meta-aramid fibrid is used as paper-making material, after being given maceration treatment and refining, similarly to ordinary wood pulp. With the view to maintain the quality suitable for paper making, meta-aramid fibrid can be given a treatment which is generally referred to as “refining”. This refining treatment can be carried out with disk refiner, beater or other paper-making material processing machine and instruments which exert mechanical cutting action.

In this operation, the form change in the meta-aramid fibrid can be monitored by freeness test method as prescribed by JIS P8121. According to the invention, the freeness of the meta-aramid fibrid after the refining treatment preferably lies within a range of 1-300 cm³, in particular, 1-200 cm³ (Canadian freeness). Meta-aramid fibrid having the freeness more than 300 cm³ is liable to invite strength deterioration of the electrode sheet prepared therefrom. On the other hand, attempts to obtain the freeness less than 1 cm³ reduce the utilization efficiency of consumed mechanical power and often lead to reduction in the processed quantity per unit time. Furthermore, the excessive size reduction of meta-aramid fibrid is apt to invite deterioration in “binder function”. Therefore, efforts to achieve the freeness less than 1 cm³ are found to produce no appreciable merit.

For the utility intended in the present invention, the weight-average fiber length of meta-aramid fibrid after the refining treatment, as measured with optical fiver length measuring apparatus, is preferably within the range generally not more than 1 mm, in particular, not more than 0.8 mm. Here, as the optical fiber length measuring apparatus, Fiber Quality Analyzer (Op Test Equipment Co.), KAJAANI Measuring Equipment (Kajaani Co.) or the like can be used. These apparatuses allow separate, individual observation of fiber length and configuration of meta-aramid fibrid passing through a certain optical path, and the measured fiber lengths are statistically processed. Where the weight-average fiber length of the meta-aramid fibrid exceeds 1 mm, reduction in electrolytic solution absorbency of the electrode sheet, occurrence of parts in the sheet which are not impregnated with the electrolyte, and furthermore rise in internal resistance of the electric/electronic parts are apt to take place.

### Solvent:

As the solvent in the present invention, any solvent in which meta-aramid fibrid can be homogeneously dispersed can be used with no particular limitation. Whereas, normally water allowing easy recovery is particularly preferred.

### Collector:

The collector in the present invention is subject to no particular limitation, so long as it is made of conductive material and is stable against the electrode, solvent and electrolytic solution. Specifically, for example, metallic thin sheets such as of aluminum, platinum, copper and the like can be used. When water is used as the solvent, for example, the collector may be given a pretreatment such as degreasing in advance, for better imbibing.

### Glass Transition Temperature:

In the present specification, glass transition temperature is a value determined as follows. A test piece is heated at a temperature rise rate from room temperature of 3° C./min. and the exothermic values are measured with differential scanning calorimeter. Two prolongation lines are drawn from the endothermic curve, and the glass transition temperature is decided as the point of intersection of a straight line passing one-half the distance between the two prolongation lines with the endothermic curve. The glass transition temperature of polyphenylene isophthalamide is 275° C.

### Method of Making the Electrode Sheet:

### 1) Slurry-Making Step:

Meta-aramid fibrid is mixed with an electrode active material and conductive agent, and stirred to form a homogeneous slurry. In this occasion, a thickener may be used within a range not detrimental to characteristic properties of intended electric/electronic parts, for controlling moldability. As the thickener, for example, water-soluble polymers such as carboxymethyl cellulose, polyethylene glycol, starch, polyvinyl alcohol, polyacrylamide and the like can be used.

### 2) Thick Sheet-Making Step:

Thus formed slurry is applied onto either a single side or both sides of a collector with a slurry application device such as a doctor knife, and either by passing it through a continuous drying oven or drying and solidifying it in a stationary type drying oven, a thick sheet is produced. The drying temperature is preferably within a range of boiling point of the solvent ±5° C., but not limited thereto.

### 3) Pressing Step:

The resultant sheet is pressed (thermal pressing), for example, between a pair of flat plates or of metallic rolls, at high temperature and high pressure, whereby the density and mechanical strength of the sheet can be improved. The electrode sheet after the pressing preferably satisfies the following inequality (1):

0.25<D×(1/D−We/De−Wc/Dc−Wb/Db)<0.75 (1)

in the inequality,

D is the density of the electrode sheet excluding the collector,

We is the weight fraction of the electrode active material,

De is the true specific gravity of the electrode active material,

Wc is the weight fraction of the conductive agent,

Dc is the true specific gravity of the conductive agent,

Wb is the weight fraction of the binder, and

Db is the true specific gravity of the binder.

When D×(1/D−We/De−Wc/Dc−Wb/Db) is 0.75 or more, usually the electrode sheet does not have a sufficiently high density, and it is difficult to secure sufficient capacity as a capacitor or battery. Conversely, when D×(1/D−We/De−Wc/Dc−Wb/Db) is 0.25 or less, usually the electrode sheet has a density too high, and power output sufficient for a battery can hardly be obtained. It is particularly preferred, furthermore, that D×(1/D−We/De−Wc/Dc−Wb/Db) is within a range of 0.3-0.73.

As the pressing (thermal pressing) conditions, for example, when metallic rolls are used, temperatures ranging 20-400° C. and linear pressure ranging 50-400 kg/cm may be used, although not limited thereto. For achieving high capacity and high power output as capacitors or batteries, it is preferred to carry out the pressing at a temperature not lower than the glass transition temperature of meta-aramid and not higher than 390° C., under a linear pressure of 100-400 kg/cm.

It is also possible, furthermore, to have the meta-aramid before the pressing contain a solvent to plasticize the meta-aramid and lower its glass transition temperature. As means for the plasticizing, there are such methods as lowering the drying temperature at the drying stage in the above thick sheet producing step to avoid complete evaporation of the solvent or spraying a solvent onto the thick sheet, but the means are not limited thereto.

Pressing only at ambient temperature without any heating operation is permissible, or the above thermal press processing may be repeated plural times. Furthermore, the sheet may be passed through the continuous drying oven once again, or dried in the stationary drying oven, after the thermal press processing. The thermal press processing and the above drying may be repeated plural times at an optional order.

### EXAMPLES

Hereinafter the present invention is explained in further details, referring to Examples. It should be understood that these Examples are given only for exemplification and are not to limit the content of the present invention in any way.

### Measuring Method:

### (1) Measurement of Weight-Average Fiber Length

The weight-average fiber length was measured as to about 4000 strands of aramid fibrid, with Fiber Quality Analyzer (Op Test Equipment Co.).

### (2) Measurement of Basis Weight and Thickness of the Sheet

Measured following JIS C2111, and those of the collector were subtracted.

### Referential Example

### Production of Electrode Sheet

### 1) Adjustment of Weight-Average Fiber Length of Meta-Aramid Fibrid

Metaphenylene isophthalamide fibrid was prepared by a method using a wet precipitation machine composed of stator-rotor combinations. This fibrid was processed with macerator and refiner to be adjusted of its weight-average fiber length.

### 2) Slurry-Making Step:

The fibrid of polymetaphenylene isophthalamide (true specific gravity: 1.38) was dispersed in water, to provide a slurry of meta-aramid fibrid.

Mixing this slurry with active carbon (true specific gravity: 2.0) and Ketchen Black (true specific gravity: 2.2) and stirring, a homogeneous slurry was prepared. The blend ratio was adjusted to make the weight ratio of the active carbon:Ketchen Black:fibrid of polymetaphenylene isophthalamide after evaporation of the water, 85:5:10.

### 3) Thick Sheet-Making Step:

The slurry as obtained in the above was applied onto single side of an aluminum foil collector (equipped with a conductive anchor) with a doctor knife, and the collector was passed through a continuous drying oven at the drying temperature of 105° C., to provide a thick sheet.

### Example 1

The thick sheet as formed in the Referential Example, in which the weight-average fiber length of the polymetaphenylene isophthalamide was adjusted to 0.9 mm, was heat-pressed between a pair of metallic rolls at 330° C., a temperature higher than the glass transition temperature (275° C.) of polymetaphenylene isophthalamide, and at a linear pressure of 300 kgf/cm to give an electrode sheet as shown in Table 1.

### Comparative Example 1

The thick sheet as formed in the Referential Example was heat-pressed between a pair of metallic rolls at a temperature of 20° C. and at a linear pressure of 300 kgf/cm to give an electrode sheet as shown in Table 1.

Main property values of those electrode sheets as obtained in Example 1, 2 and Comparative Example 1 are shown in Table 1.

TABLE 1

| | | | | Comparative |
|---|---|---|---|---|
| Property | Unit | Thick sheet | Example 1 | Example 1 |
| Basis weight | g/m² | 57.4 | 57.4 | 57.4 |
| Thickness | μm | 205 | 108 | 151 |
| Density | g/cm³ | 0.28 | 0.53 | 0.38 |
| A | | 0.854 | 0.724 | 0.802 |

In Table 1, A denotes the formula: D×(1/D−We/De−Wc/Dc−Wb/Db), in which D, We, De, Wc, Dc, Wb and Db are as previously defined.

As is clear from Table 1, the electrode sheet of Example 1 has a sufficiently high density and a value of D×(1/D−We/De−Wc/Dc−Wb/Db) which falls in a suitable range. Furthermore, because meta-aramid which is highly heat-resistant and electrochemically stable is used as the binder, the electrode sheet withstands high-temperature drying, and is very useful as an electrode sheet for electric/electronic parts such as highly voltage-resistant capacitors and batteries.

1. A method for producing an electrode sheet by applying onto a collector a slurry which comprises an electrode active material, electroconductive agent, binder and solvent, characterized in that fibrid of meta-aramid is used as the binder, and that the electrode sheet is pressed.

2. The method of claim 1 wherein the fibrid of meta-aramid has a weight-average fiber length not more than 1 mm.

3. The method of claim 1 wherein the electrode sheet is pressed at a temperature not lower than the glass transition temperature of the meta-aramid.

4. The method of claim 1 wherein glass transition temperature of the fibrid of meta-aramid is lowered by having the fibrid of meta-aramid contain a solvent and whereby plasticizing it before pressing the electrode sheet.

5. The method of claim 1 wherein the solvent is water.

6. An electrode sheet produced by the method of claim 1 which satisfies the following inequality (1)
0.25<D×(1/D−We/De−Wc/Dc−Wb/Db)<0.75 (1)
wherein:
D is the density of the electrode sheet excluding the collector;
We is the weight fraction of the electrode active material;
De is the true specific gravity of the electrode active material;
Wc is the weight fraction of the conductive agent;
Dc is the true specific gravity of the conductive agent;
Wb is the weight fraction of the binder, and
Db is the true specific gravity of the binder.

7. Electric and electronic parts in which the electrode sheet of claim 6 is used.

8. Capacitors in which the electrode sheet of claim 6 is used.

9. Batteries in which the electrode sheet of claim 6 is used.
